(19) United States
(12) Patent Application Publication
(10) Pub. No.: US 2024/0053594 A1
(43) Pub. Date: Feb. 15, 2024

(54) Method and Device for Microscopy

(71) Applicant: Carl Zeiss Microscopy GmbH, Jena (DE)

(72) Inventors: Joerg Steinert, Jena (DE); Tiemo Anhut, Jena (DE); Daniel Schwedt, Jena (DE); Wiebke Hilbert, Jena (DE); Gerd Heisse, Jena (DE)

(21) Appl. No.: 18/231,988

(22) Filed: Aug. 9, 2023

(30) Foreign Application Priority Data
Aug. 10, 2022 (DE) 10 2022 120 155.4

(51) Int. Cl. G02B 21/00; G02B 21/36

(52) U.S. Cl. CPC G02B 21/008; G02B 21/361; G02B 21/0032

(57) ABSTRACT

Microscopy and a device for microscopy where with a light field arrangement comprising a multi-lens array and a camera having at least one camera sensor, image data sets which each contain at least one partial image of a sample are successively recorded. To increase a number of the image data sets recordable per unit time, a) measurement data only from a first number of pixels less than a total number of pixels of the at least one camera sensor are read out; b) measurement data only from a second number of pixels less than the total number of pixels or the first number of pixels read are processed further; and/or c) for some or all of the total number of pixels or the first number of pixels read, measurement data are processed further with a bit depth which is less than a maximum possible bit depth.

### REFERENCE TO RELATED APPLICATIONS

The current application claims the benefit of German Patent Application No. 0 2022 120 155.4, filed on 10 Aug. 2023, which is hereby incorporated by reference.

### FIELD OF THE DISCLOSURE

The invention relates to a method for microscopy, in particular for light field microscopy, and a device for microscopy, in particular for light field microscopy.

### BACKGROUND OF THE DISCLOSURE

In a method of the generic type, by means of a light field arrangement comprising at least one multi-lens array and a camera having at least one camera sensor, image data sets which each contain at least one partial image of a sample are successively recorded. Measurement data from pixels of the at least one camera sensor are in each case read out in the process.

A device for microscopy, in particular for light field microscopy, of the generic type comprises at least the following components: a light source for emitting excitation light, an illumination beam path for guiding the excitation light onto or into a sample, a detection beam path at least comprising a microscope objective and a multi-lens array for guiding emission light to a camera, said emission light being emitted by the sample as a consequence of being impinged on by the excitation light, the camera for sequentially recording image data sets which each contain at least one partial image of the sample, the camera having at least one camera sensor and a camera controller, and a control unit for interacting at least with the camera controller and for evaluating image data supplied by the camera.

A method of the generic type and a device of the generic type are described for example in Vol. 27, No. 18/2 Sep. 2019/Optics Express 25573.

For simultaneous three-dimensional fluorescence microscopy, in recent years light field microscopy has increasingly been discussed, wherein by means of a multi-lens array in front of the camera, spatial information and angle information are captured simultaneously by means of a single camera image, such that the volume information can be deduced from these data.

One field of application for light field microscopy is modern biomedical research, which is increasingly concerned with the microscopic examination of processes in living samples. Light field microscopy accomplishes the requisite simultaneous recording of the signals in all three dimensions of the sample. In particular, there is often interest in temporal developments of processes in a sample. So-called Fourier light field microscopy has turned out to be a variant of light field detection that is preferred for microscopy. In this case, the multi-lens array is introduced into a plane conjugate to the back focal plane of the microscope objective. Many real images then arise on the camera sensor, these images being referred to hereinafter as partial images and each corresponding to a different viewing direction towards the sample. A camera sensor having a large number of pixels, for example more than 20 megapixels, is required for detecting the partial images. For some applications, for example if calcium transients are intended to be detected, frame rates of at least 50 fps (fps=frames per second) are required. By way of example, it is possible to use a camera in which 25 megapixels are read with a bit depth of 10 bits and at up to 150 fps, which corresponds to a data rate of approximately 5 GB/s.

The transmission, processing and storage of such large amounts of data are then subject to technical constraints which actually limit the achievable image repetition rates. By way of example, a first limitation may result from the speed at which the camera sensor, for example of a CMOS camera, can be read. The maximum readout speed in the case of CMOS-like sensors is usually a model-dependent fixed value which can be in the range of a few GB/s. This value defines the readout duration of a certain number of image lines for a defined bit depth.

A further limitation may result during the transmission of the image data, for example from the camera to a control unit. There may then be limitations during the processing of the raw image data, for example in a camera driver in the control unit, and, finally, the processing of the image data in the control unit itself may also be a limiting factor. Overall, the methods and devices to be used are therefore presented with the challenge of first transmitting the large amounts of data from the camera to the control unit and processing them further there.

### SUMMARY OF THE DISCLOSURE

An object of the present invention can be considered that of providing a method and a device for microscopy, in particular for light field microscopy, which make it possible to increase the image repetition rates.

This object is achieved by means of the method having the features of claim 1 and by means of the device having the features of claim 19.

Advantageous variants of the method according to the invention and preferred exemplary embodiments of the device according to the invention are explained below, particularly in association with the dependent claims and the figures.

According to the invention, the method of the type specified above is developed by virtue of the fact that in order to increase a number of the image data sets which are recordable per unit time, at least one of the following method steps is carried out:
a) measurement data only from a first number of pixels of the at least one camera sensor are read out, the first number being less than a total number of the pixels;
b) measurement data only from a second number of pixels of the at least one camera sensor are processed further, the second number being less than a or the first number of the pixels read;
c) for some or all of a or the first number of pixels read, measurement data are processed further with a bit depth which is reduced in comparison with a maximum possible bit depth.

According to the invention, the device of the type specified above is developed by virtue of the fact that in order to increase a number of image data sets which are recordable per unit time, at least one of the following features is realized:
A) the camera controller is configured to read out measurement data only from a first number of pixels of the at least one camera sensor, the first number being less than a total number of the pixels;
B) the control unit and/or the camera controller are/is configured to process further measurement data only from a second number of pixels of the at least one camera sensor, the second number being less than a or the first number of the pixels read;
C) the control unit and/or the camera controller are/is configured to process further measurement data from some or all of the pixels read with a bit depth which is reduced in comparison with a maximum possible bit depth.

The excitation light is electromagnetic radiation, in particular in the visible spectral range and adjoining ranges. The only demand placed on the contrast-providing principle by the present invention is that the sample emits emission light as a consequence of the irradiation by the excitation light and/or deflects, scatters or reflects back the excitation light. The emission light is then deflected excitation light, scattered excitation light or excitation light reflected back in some other way. Typically, the emission light is fluorescence light which the sample, in particular dye molecules present there, emits or emit as a consequence of the irradiation by the excitation light.

At least one light source, for example a laser, is present for providing the excitation light. The spectral composition of the excitation light can be settable, in particular between two or more colors. The excitation light can also simultaneously be polychromatic, for example if different dyes are intended to be detected simultaneously. In principle, known components that provide the desired excitation light having the desired intensity and in the desired wavelength ranges can be used as light source. LED sources, lasers or gas discharge lamps are typically used.

The term “illumination beam path” denotes all optical beam-guiding and beam-modifying components, for example lenses, mirrors, prisms, gratings, filters, stops, beam splitters, modulators, e.g. spatial light modulators (SLM), by means of which and via which the excitation light from the light source is guided to the sample to be examined. The excitation light can be guided onto the sample by a microscope objective, in particular the same microscope objective which is also part of the detection beam path.

No particular demand is placed on the microscope objective or the microscope objectives. In particular, immersion objectives can be used.

The back focal plane of the microscope objective and planes optically conjugate thereto are also referred to as pupil planes.

The method according to the invention and the device according to the invention are suitable in principle for any type of samples which are accessible to examination by light field microscopy.

Light that is emitted and/or deflected, for example scattered, generally radiated, by the sample to be examined as a consequence of the irradiation by the excitation light can be referred to as emission light and reaches the camera via the detection beam path. The term “detection beam path” denotes all beam-guiding and beam-modifying optical components, for example lenses, mirrors, prisms, gratings, filters, stops, beam splitters, modulators, e.g. spatial light modulators (SLM), by means of which and via which the emission light is guided from the sample to be examined to the camera sensor. In particular, the microscope objective and the multi-lens array are part of the detection beam path.

In this application, the term “light field arrangement” denotes an optical arrangement having at least one multi-lens array and a camera. The light field arrangement serves to record image data sets from a sample, each of which image data sets can comprise many partial images, although not every one of the partial images need be read out and/or evaluated. In principle, for realizing the method according to the invention, it is sufficient for a single partial image to be read out and/or evaluated. The multi-lens array contains a plurality, e.g. a few tens, of individual lenses and serves to image light emitted by a sample onto the camera. The individual lenses can be arranged on a grid, for example a hexagonal grid. The lenses of the multi-lens array can be microlenses, in particular, and the multi-lens array can also be referred to as a microlens array.

The lenses of the multi-lens array need not necessarily all be arranged in the same plane, rather they can also be arranged in somewhat different planes. A certain level of defocusing is tolerable, moreover. In the case of the device according to the invention and in the case of the method according to the invention, the camera sensor can be arranged in a focal plane of at least one lens of the multi-lens array.

The lenses of the multi-lens array can all be identical in regard to their optical parameters. However, it is also possible for the multi-lens array to have different lenses. By way of example, a diameter of a central lens can be greater than that of all the other lenses. The central lens can then serve for recording an overview image.

Preferably, the multi-lens array can be arranged in a plane optically conjugate to the back focal plane of the microscope objective, or in the vicinity of such a plane (Fourier light field microscopy). Alternatively, the multi-lens array can be arranged in an intermediate image plane or in the vicinity of an intermediate image plane. Mixed forms of these variants are also possible.

In particularly preferred variants of the device according to the invention and of the method according to the invention, the camera sensor is arranged in a focal plane of a plurality, in particular all, of the lenses of the multi-lens array or in the vicinity of these focal planes.

It is preferred for the camera sensor to be arranged in a focal plane of the lenses of the multi-lens array or in any case in the vicinity of this focal plane. However, that is not absolutely necessary for realizing the present invention. All that is necessary is that the multi-lens array is arranged in a defined and known position relative to the camera sensor.

The camera is a two-dimensionally spatially resolving detector. The light is actually detected by the camera sensor having a multiplicity of pixels. The camera sensor is a fast optical detector comprising a two-dimensionally spatially resolving sensor area. The camera sensor can be a camera chip, in particular a CCD, CMOS, sCMOS or SPAD camera chip. The pixels can be arranged in any desired way, in principle, on the camera sensor. In general, the pixels are arranged in lines and columns. However, other grid-shaped arrangements are also possible, for example hexagonal grids.

The camera has a camera controller, which controls the readout of the individual pixels. The signals measured by each of the pixels are typically amplified, impedance-converted, digitized and then provided at an interface of the camera controller for further processing.

The camera controller can contain a microcontroller or an FPGA or can be realized by a microcontroller or an FPGA or by similar programmable components.

The bit depth is the digital resolution with which the signal detected by the pixels of the camera sensor is provided by the camera.

An image data set is the totality of the optical information measured by the camera sensor at a specific point in time. The term “partial image” denotes a part of the image data set which can be assigned to a specific lens of the multi-lens array. The partial images each contain image data. The term “image data of a partial image” denotes the totality of the measurement data of the individual pixels that the partial image consists of.

The term “control unit” denotes all hardware and software components which interact with the components of the microscope according to the invention for the intended functionality of the latter. In particular, the control unit can have a computing device, for example a PC, and a camera driver capable of rapidly reading out measurement signals. The computer resources of the control unit can be distributed among a plurality of computers and optionally a computer network, in particular also via the Internet. The control unit can have in particular customary operating devices and peripherals, such as mouse, keyboard, screen, storage media, joystick, Internet connection. The control unit can read in the image data from the camera sensor, in particular. The control unit can also be used and configured for controlling the light source.

The reconstruction of the three-dimensional images of the examined sample from a recorded image using parameters of the light field arrangement, such as numerical aperture of the microscope objective, number of illuminated lenses of the multi-lens array, optical parameters of the multi-lens array, other settings of the detection beam path, can be performed by the control unit, but in principle also by some other computing unit.

What can be regarded as an essential concept of the invention, in contrast to the prior art, is no longer reading all the pixels of the camera and evaluating the corresponding measurement data, but rather defining individually in each measurement which of the pixels of the camera will be read and/or the measurement data of which pixels will be evaluated. The invention has recognized that the information content of the measurement data of the pixels of the camera sensor is not the same everywhere, but rather can be different in different regions of the camera sensor. Depending on the implementation of the light field concept, for example in Fourier light field microscopy, there may be regions of the camera sensor which contain no, or in any case no significant, image data information or the image information of which is not necessarily required for the image generation.

If the data processing in the camera or in the control unit is adapted according to one of the methods according to the invention, the data rates in light field microscopy can be significantly reduced and the achievable image repetition rates can accordingly be significantly increased. Accordingly, the temporal resolution for the observation can be increased.

Specifically, if only the desired image data are transmitted, the data rates can be reduced by a factor of up to more than 50 and the achievable frame rate can accordingly be increased.

A prerequisite, clearly, is that other constraints do not actually limit the achievable frame rates, in other words that the essential limiting factor for the achievable frame rate is actually the amount of data to be transmitted, stored and evaluated.

In principle, it is sufficient for an image data set to contain just a single partial image. A reconstruction of three-dimensional sample information is not necessary in that case. By way of example, that may be sufficient to obtain an overview image of a sample. For the more common case, however, in which the image data sets each contain a plurality of partial images, three-dimensional sample information can be reconstructed at least from a selection of image data of the partial images. For this purpose, a large number of known methods and algorithms are available, which can be implemented in the control unit, in particular.

Expediently, the control unit is configured for reconstructing three-dimensional sample information at least from a selection of the image data supplied by the camera.

In one particularly preferred variant of the method according to the invention, the number of the image data sets of the camera sensor which are recorded per unit time is increased by reducing a number of the pixels to be read.

By way of example, if the camera sensor or camera chip is to be read line by line, it is possible not to read specific lines about which it is known that the measurement data from the pixels thereof do not contain, or cannot contain, any information or any relevant information on account of the parameters of the detection beam path.

By way of example, it is possible that pixels in one region or in a plurality or all of the regions of the camera sensor for which one or more of the following conditions are satisfied are not read or the measurement data thereof are not, or not completely, evaluated:
the measurement data of the pixels in the region or the regions contain no image information;
the measurement data of the pixels in the region or the regions cannot contain image information;
sample information can be extracted only with difficulty from the measurement data of the pixels in the region or the regions;
the measurement data of the pixels in the region or the regions are not required for the reconstruction of three-dimensional sample information.

Advantages can additionally be achieved if, e.g. rectangular, image fields are oriented favorably relative to lines and columns of the image sensor. Depending on the technical implementation of the camera sensor, the readout speed of the camera sensor itself can also be increased. If this readout speed is what limits the image repetition rate, the achievable image repetition rate can thus be increased.

Particularly preferably, the partial images of an image data set are rectangular and the camera sensor is oriented relative to the partial images such that pixel lines and pixel columns of the camera sensor are aligned parallel to the edges of the partial images. In that case, the pixels of those lines and/or columns which lie between the individual partial images can be omitted particularly effectively during readout.

In principle, it is also possible for the camera sensor to have a different symmetry, e.g. arrangement of the pixels on a hexagonal grid, and for the partial images then to have a matching symmetry, for example a regular hexagonal shape.

Advantageously, the hexagonal partial images are then aligned on the camera sensor such that the edges of the regular hexagons are in each case oriented parallel to the directions of the hexagonal grid of the camera sensor.

The invention generally allows a compromise to be chosen between an achievable image repetition rate and the processed information. In other words, it is possible to effect scaling between the image repetition rate and the image information. The extreme cases between which a suitable compromise can respectively be chosen are maximum image quality with reduced image repetition rate, on the one hand, and maximum image repetition rate with reduced image quality, on the other hand.

In light field microscopy, e.g. in Fourier light field microscopy, the image information can be reduced here by not transmitting and/or not processing pixels in sensor regions without image information. These can be for example regions of the camera sensor which are not supported optically, for instance on account of a field limitation of the objectives or a restriction of an illuminated region of the sample.

It is likewise possible for regions of the camera sensor to be excluded from the transmission, and/or not to be read, in which image information is indeed found, but sample information can be obtained therefrom only with difficulty. This is the case for example in intermediate regions with crosstalk or regions in which individual partial images overlap.

In advantageous variants of the device according to the invention, the control unit has a camera driver and/or a frame grabber.

What is particularly important for the present invention, moreover, is that the method steps can be carried out in different components of the device according to the invention. This corresponds to the insight that limitations of the image recording rate may be brought about by different components of the system. Supplementarily or alternatively, for example, in a further preferred configuration of the method according to the invention, at least one of the method steps of
selecting pixels of the camera sensor that are to be evaluated and/or read;
processing measurement data from pixels of the camera sensor that are to be evaluated;
   can be carried out partly or completely in one or more of the following components:
camera controller, in particular microcontroller or FPGA;
camera driver of the control unit;
frame grabber of the control unit.

By way of example, the data rate can be reduced when transmitting the data from the camera to the control unit, in a camera driver for the camera in the control unit and/or when reading out the image data from the camera driver in the control unit.

Supplementarily or alternatively, in a further important configuration of the method according to the invention, a number of partial images of an image data set that are to be evaluated can be reduced in order to increase a number of the image data sets which are recordable per unit time. This measure results from the insight that for specific measurement tasks it is sufficient if three-dimensional volume information is reconstructed using only a selection instead of all maximally possible partial images. By way of example, that may be the case if a three-dimensional overview image is intended to be created before the recording of detail measurements. The partial images of the image data set that are to be evaluated can be arranged on the camera sensor in a regular grid, for example. The regular grid can be a subset of the complete grid of the partial images of all the lenses of the multi-lens array.

Supplementarily or alternatively, it is also possible that a size of the image field during the recording of one image data set or a series of image data sets in the case of one partial image or a plurality or all of the partial images is reduced in comparison with a maximum possible size of the image field.

Such a targeted limitation of the image field size can be advantageous for example if the image quality is reduced, for instance as a result of vignetting or imaging aberrations in the edge regions of partial images.

Furthermore, a targeted limitation of the image field size can be expedient in order to achieve a reduction of the data rates and thus an increase in the achievable image repetition rates.

A further reduction of the number of the pixels to be read and/or of the data to be evaluated is possible if, in addition or as an alternative to the measures described previously, the size of an image field of at least one partial image or the size of an image field of a plurality or all of the partial images in the case of a sequence of recordings of image data sets is altered from one recording to the following recording. A, in particular controllable, field stop can expediently be present for the purpose of setting a size of the image field in the detection beam path. The size of the partial images can then be altered by setting the field stop. The controllable field stop can be controlled by the control unit, in particular.

In principle, it is possible that that the measurement data from one partial image or from a plurality or all of the partial images of an image data set are evaluated in an identical fashion, in particular before methods for reconstructing the three-dimensional sample information are used.

The different types of data reduction can also be combined differently for different partial images (e.g. The different partial images of the individual lenses of the multi-lens array). For example, the resolution or the image field can be reduced only for specific partial images or can be reduced differently for different partial images.

In one preferred configuration of the method according to the invention, the measurement data from one partial image or from a plurality or all of the partial images of an image data set are evaluated differently, in particular before methods for reconstructing the three-dimensional sample information are used. By means of this measure, which can in turn be used in addition or as an alternative to the variants described above, the evaluation of the individual partial images can be individually adapted to the requirements that exist in each case, and time can be saved by this means, too.

Advantageous variants of the method are also possible if the multi-lens array is configured such that the lenses have different properties (e.g. diameter, numerical aperture, focal length). In this case, too, the partial images which are to be respectively assigned to the individual lenses can be treated differently. By way of example, the diameter of the central lens of the multi-lens array can be significantly greater than that of all the other lenses, which has the effect that this lens also encompasses a larger region of the objective pupil and therefore yields a better resolution. In that case, by means of the proposed method, this partial image can be transmitted with full resolution, for example, while all the further partial images are transmitted optionally with lower resolution.

It is thus possible for example for at least one of the parameters
size of the image field,
resolution,
bit depth
   to be defined individually in each case for one partial image or a plurality or all of the partial images, in particular depending on the properties of that lens of the multi-lens array which has generated the relevant partial image on the camera sensor.

Substantial reductions of the regions to be evaluated in the partial images are additionally possible if a region illuminated on and/or in the sample is varied temporally and/or spatially. It is then sufficient to read out and/or evaluate only those regions of the partial images which correspond to illuminated regions of the sample.

By way of example, the sample can be illuminated. The light sheet can be oriented in particular obliquely with respect to the optical axis. Other orientations of the light sheet are possible, however; by way of example, the light sheet can also be oriented parallel to the optical axis, in particular of a central lens of the multi-lens array. Preferably, the light sheet is scanned through the sample, different regions on or in the sample being illuminated depending on the scanning position of the light sheet. In that case, the partial images of an image data set in each case show an only partly illuminated sample.

In one exemplary embodiment of the device according to the invention, for this purpose, the illumination beam path can comprise a scanner for the purpose of spatially and temporally manipulating a region illuminated on and/or in the sample. Preferably, the control unit is configured for controlling the scanner and/or the field stop.

By way of example, the illumination beam path can be configured for illuminating the sample with a light sheet. The light sheet can be oriented in particular obliquely with respect to the optical axis. Other orientations of the light sheet are possible, however; by way of example, the light sheet can also be oriented parallel to the optical axis, in particular of a central lens of the multi-lens array.

An adaptation to a specific illumination structure can then be performed as well. That is important if, as described for example in WO2015/124648, the sample is illuminated with a light sheet which is inclined with respect to the optical axis. The light sheet is scanned and then illuminates different regions of the sample at different times. With simultaneous Fourier light field microscopy during detection, an only partially illuminated sample structure then appears in each partial image. It can be advantageous to read, to transmit and/or to evaluate only those pixels of the camera sensor which correspond to these regions. In this case, it is necessary to ensure a transmission of information from the illumination to the detection via the control unit.

The size of the illuminated field of view can be set by a variant of the device which has a laser scanning microscope. The size of the sample region illuminated by the laser scanning microscope (LSM) can be set by the control unit. At the same time the control unit can reprogram the camera controller, for example an FPGA, of the camera depending on the size and position of the regions of the camera that are to be read.

Preferably, the numerical aperture of the LSM can be set and can be reduced, for example by a factor of 10× or more, in order to increase the depth of focus of the illumination. Particularly preferably, the LSM can be configured for an oblique light sheet illumination in the sample plane.

Moreover, the control unit can correspondingly control a camera driver and/or a frame grabber in order that the data packets are correctly read out, received, stored and evaluated.

One preferred variant of the method is characterized in that a region of the pixels of the camera sensor that are to be read and/or evaluated is coordinated with a region illuminated on or in the sample in such a way that only measurement data from pixels in regions of the camera sensor which correspond to illuminated regions of the sample are evaluated.

Accordingly, the control unit can preferably be configured to coordinate a region of the pixels of the camera sensor that are to be evaluated and/or read with a region illuminated on or in the sample in such a way that only measurement data from pixels in regions of the camera sensor which correspond to illuminated regions of the sample are evaluated.

A further important group of variants of the method according to the invention is distinguished by the fact that, supplementarily or alternatively, in the case of a selection of image data of an image data set or in the case of all image data of an image data set, a dynamic range is reduced in comparison with a dynamic range with which the image data were originally recorded.

The term “dynamic range” is taken to mean, in particular, the ratio of the largest measurement values or measurement data to the smallest measurement values or measurement data. The terms “measurement values” and “measurement data” are taken to mean, in particular, the digitized measurement values and, respectively, the measurement data of the individual camera pixels.

The dynamic range can be reduced by reducing the bit depth. By way of example, less significant bits of the measurement data can be excised, thus deleted or omitted. The dynamic range, the intensity resolution and the data rate are thus reduced.

On the other hand, at low light intensities, if a number of more significant bits yield zero throughout, these more significant bits of the measurement data can be excised, thus deleted or omitted. The data rate is thus likewise reduced. The dynamic range and the intensity resolution remain the same, however.

In particular, the image data can be compressed by a, for example linear, compression method in order to reduce the dynamic range. Nonlinear compression methods are possible as well; by way of example, the root of the measurement data can be formed in order to reduce the dynamic range. Generally, a native bit depth of the camera can be mapped onto a sufficient reduced bit depth by means of a table (mapping).

A substantial reduction of the data to be processed and to be transmitted is additionally possible if the resolution of the camera is reduced in comparison with a maximum possible resolution. For example, the resolution of the camera can be reduced by binning, i.e. by combining pixels of the camera sensor. When reducing the resolution of the camera, it is necessary to take account of the fact that the Nyquist limit for the spatial sampling may be undershot depending on the wavelength and design of the optical system. This is significant if the point spread function of the emission of individual dye molecules is intended to be measured in a spatially resolved manner.

A further preferred exemplary embodiment of the device is distinguished by the fact that the illumination beam path comprises a microscope objective and a stop for setting a numerical aperture of the microscope objective. The stop can preferably be arranged in a back focal plane of the microscope objective or a plane optically conjugate thereto (pupil plane), or in the vicinity of such a plane.

The depth of focus of the detection and/or excitation can be set by the stop.

In principle, it is possible for the microscope objective of the illumination beam path and the microscope objective of the detection beam path to be different microscope objectives. However, it is also possible for the microscope objective of the illumination beam path and the microscope objective of the detection beam path to be one and the same microscope objective. In the latter case, a beam splitter for separating the illumination and detection beam paths is necessary.

Generally, all methods described here for data reduction and for increasing the image repetition rate can be combined with one another.

### BRIEF DESCRIPTION OF THE DRAWINGS

Further advantages and features of the invention are explained below with reference to the figures, in which:

FIG. 1 shows a schematic view of a device according to the invention;

FIG. 2 shows a schematic view of a camera and a control unit for a device according to the invention;

FIG. 3 shows a first example of an arrangement of partial images of an image data set on a camera sensor of the camera;

FIG. 4 shows a second example of an arrangement of partial images of an image data set on a camera sensor of the camera;

FIG. 5 shows a third example of an arrangement of partial images of an image data set on a camera sensor of the camera; and

FIG. 6 shows one exemplary embodiment of a multi-lens array which can be used in a device according to the invention.

Identical and identically acting components are generally identified by the same reference signs in the figures.

### DETAILED DESCRIPTION OF EXAMPLE EMBODIMENTS

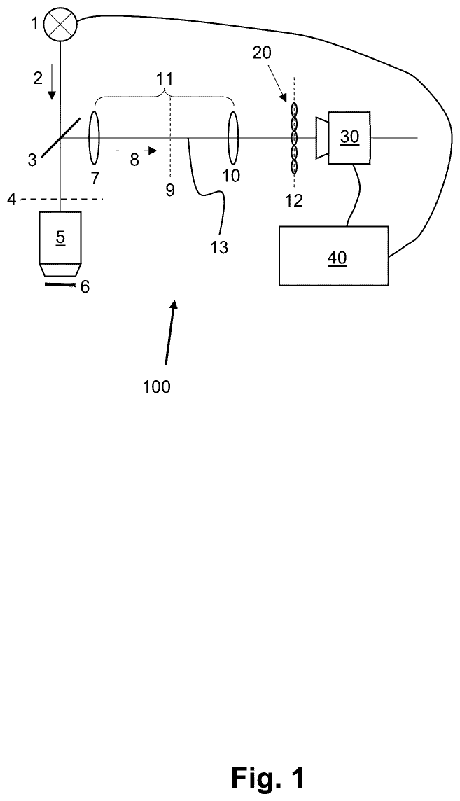

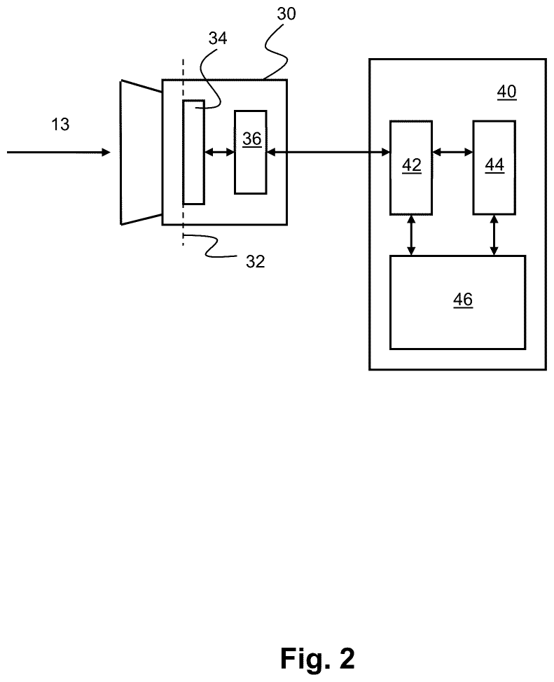

One example of a device 100 according to the invention for microscopy, in particular for light field microscopy, which is suitable and configured for carrying out the method according to the invention is explained with reference to FIGS. 1 and 2.

The device 100 includes the following as essential components: a light source 1, typically one or more lasers, for emitting excitation light 2, an illumination beam path with a microscope objective 5 for guiding the excitation light 2 onto or into a sample 6, a camera 30 with at least one two-dimensionally spatially resolving camera sensor 34 (see FIG. 2) for detecting light, in particular emitted emission light 8, radiated by the sample 6 as a consequence of being impinged on by the excitation light 2, and a detection beam path with the microscope objective 5 and a multi-lens array 20 for guiding the light 8 emitted by the sample 6 onto the camera 30. The camera sensor 34 of the camera 30 is arranged in a focal plane 32 or in the vicinity of a focal plane of the multi-lens array 20 and can typically be an sCMOS, CMOS, CCD or SPAD sensor. The multi-lens array 20 could also be part of the microscope objective 5 and be arranged in the back focal plane thereof.

The camera 30 has a camera controller 36 besides the at least one camera sensor 34. Finally, a control unit 40 is present, which interacts with the camera controller 36 and is configured for evaluating the image data supplied by the camera 30 and which can be in particular a computer of fundamentally known nature.

The control unit can be realized by a single computer. However, it is also possible for the control unit to have a plurality of computers which each carry out different tasks. In this respect, the control and evaluation unit can also comprise functional units which are arranged at different locations and, if appropriate, are far away from one another and connected to one another via the cloud. For interaction with a user, the control unit 40 can have fundamentally known functional components, such as mouse, joystick, keyboard, screen, loudspeaker, camera, Internet connection.

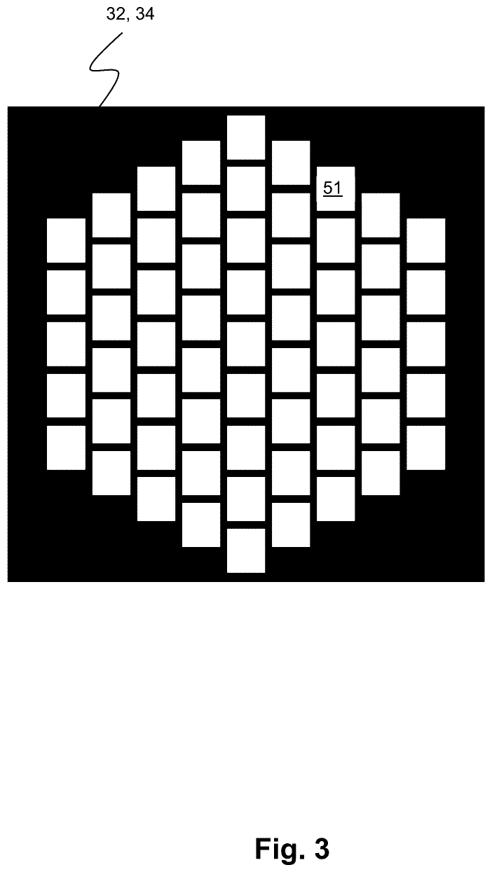

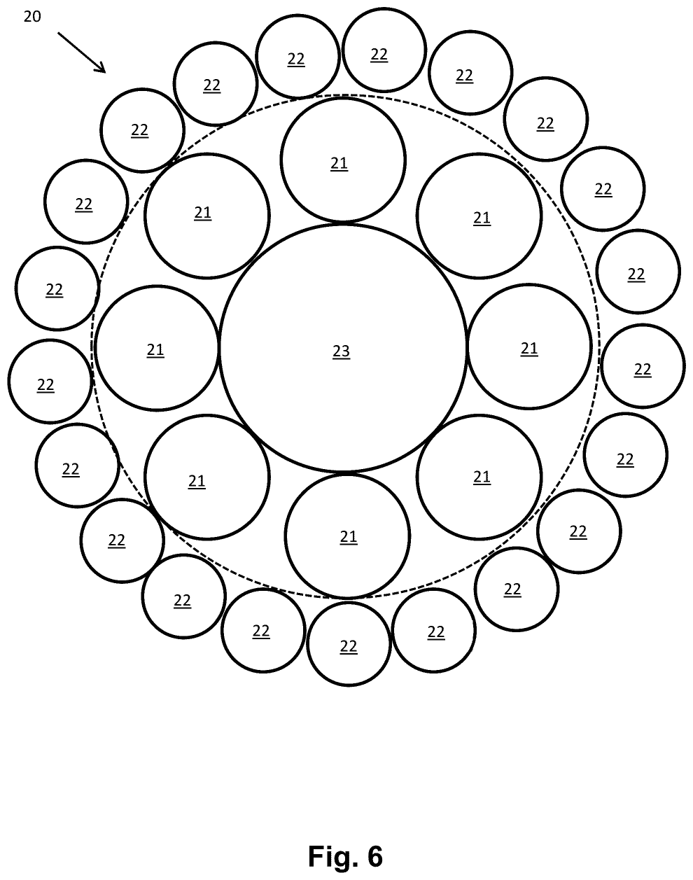

The light 2 emitted by the light source 1, in particular excitation light for fluorescent dyes used to prepare the sample 6, reaches the microscope objective 5 through a dichroic beam splitter 3 and is focused into a sample plane on or in the sample 6 by means of said microscope objective. Emission light emitted by the sample 6, in particular fluorescence light emitted by fluorescent dyes, returns to the dichroic beam splitter 3 via the microscope objective 5 and is reflected at said dichroic beam splitter in the direction of a relay optical unit 11. The relay optical unit 11 consists of two lenses 7 and 10 arranged like a telescope with respect to one another. An intermediate image plane, i.e. a plane optically conjugate to that plane into which the excitation light is focused, is situated at the position 9. After passing through the relay optical unit 11, the emission light 8 reaches the multi-lens array 20, which in this exemplary embodiment is arranged in a plane 12 optically conjugate to the back focal plane 4 of the microscope objective 5 (objective pupil BFP). The individual lenses 21, 22, 23 (see FIG. 6) of the multi-lens array 20 generate partial images 51, 52, 53 (see FIGS. 3 to 5) on the camera sensor 34 arranged in a focal plane 32 of the multi-lens array 20, said partial images respectively being individual images of the sample 6 from different angles, more precisely: different parallax angles.

The reference sign 13 denotes the optical axis of the detection beam path in the region of the camera 30. An image data set recorded by the device 100 in each case comprises a set of partial images.

The arrangement with the multi-lens array 20 arranged in a pupil plane, shown in FIG. 1, is a set-up for Fourier light field microscopy. Alternatively, what is known as spatial domain light field microscopy would also be possible for implementing the invention, within the scope of which a multi-lens array is arranged in a plane in the detection beam path optically conjugate to the object plane (rather than the back focal plane 4 of the microscope objective 5). The raw image information obtained by the spatial domain light field microscopy is related to that obtained by Fourier light field microscopy by way of a Fourier transform. Ultimately, the result of both methods is in principle the same, however. Intermediate forms are possible, too, in which the multi-lens array 20 is situated between an intermediate image plane and pupil plane.

The control unit 40 additionally contains a camera driver 42, a frame grabber 44 and a central computing unit 46, which can serve in particular to implement the algorithms for reconstructing three-dimensional sample information from the recorded image data sets 50.

The number, size and relative position on the camera sensor 34 of the pixel regions of the camera sensor 34 that are to be read and/or processed are settable and can be programmed in particular in the camera controller 36 and/or the control unit 40, in particular the camera driver 42 and/or the frame grabber 44. By way of example, the structures to be read can be stored in the camera controller 36 and/or the control unit 40, in particular in the camera driver 42 and/or the frame grabber 44, for example in the form of tables.

In real embodiments, the device 100 according to the invention can comprise numerous further optical components, in particular mirrors, lenses, color filters and stops, the function of which is known per se and which are therefore not specifically described in the present description. Furthermore, controllable components which influence the wavefronts of the propagated light can be present, for example spatial light modulators and/or deformable mirrors. These components are likewise not illustrated in FIG. 1.

According to the invention, in order to increase a number of image data sets 50 which are recordable per unit time, at least one of the following features is realized:
A) the camera controller 36 is configured to read out measurement data only from a first number n_{R} of pixels of the camera sensor 34, the first number n_{R} being less than a total number of the pixels;
B) the control unit 40 and/or the camera controller 36 are/is configured to process further measurement data only from a second number n_{E} of pixels of the camera sensor 34, the second number n_{E} being less than a or the first number n_{R} of the pixels read;
C) the control unit 40 and/or the camera controller 36 are/is configured to process further measurement data from some or all of the pixels read with a bit depth which is reduced in comparison with a maximum possible bit depth.

FIGS. 3 to 5 show examples of how the number and the size of the partial images of an image data set 50 can be arranged on the camera sensor 34 in the focal plane 32 of the multi-lens array 20. In all three examples, the partial images are arranged on a regular hexagonal grid. This reflects the circumstance that the individual lenses of the multi-lens array 20 are also arranged on a regular hexagonal grid. Such an arrangement is not absolutely necessary. One example of a multi-lens array in which the individual lenses are not arranged on a regular hexagonal grid and moreover are not all identical is explained further below in association with FIG. 6. In the examples in FIGS. 3 to 5, the multi-lens array 20 has 61 individual lenses.

In FIG. 3, the individual partial images 51 each have the same maximum image field size. In this situation, 45% of the area of the camera sensor 34 is occupied by partial images 51. If it is possible for only the illuminated pixels of the camera sensor 34 to be read, a reduction of the amount of data by a factor of 2.2 can thus be achieved. The situation illustrated in FIG. 3 can correspond to normal operation.

The sizes of the partial images can be dynamically adapted to the settings of an experiment that are effected by a user. One example of this would be that after navigation through a sample with a maximum possible image field, the size of an illuminated field of view or image field is restricted, for example to only 70% of a maximum value, for instance because the structures of interest are situated in this reduced field of view.

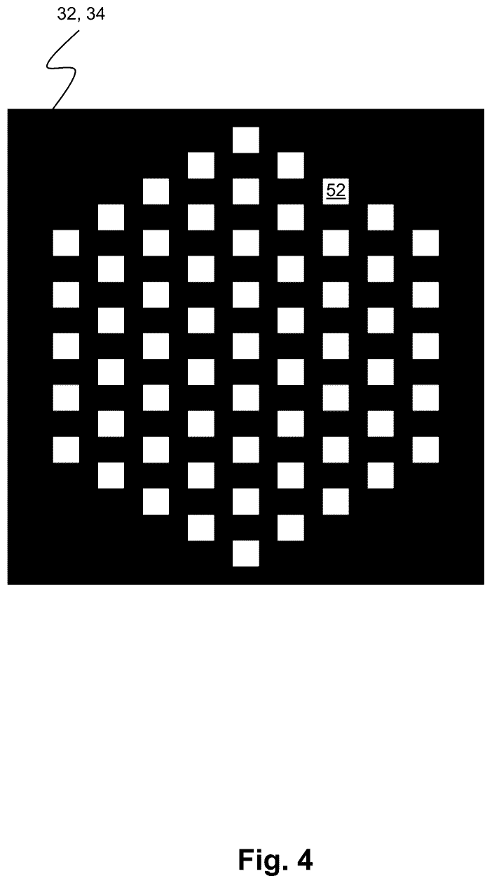

This is illustrated in FIG. 4, where again, corresponding to the 61 individual lenses of the multi-lens array, 61 partial images 52 with the same image field size in each case are imaged on the camera sensor 34. However, the image field size is reduced by 70% in comparison with the maximum image field size in FIG. 3. This can typically be achieved by means of a field stop, which can be arranged in the plane 9 for example in FIG. 1, for example under the control of the control unit 40. This reduction of the image field size has the effect that in FIG. 4 only 18% of the total area of the camera sensor 34 is occupied by partial images 52. If it is technically possible to read only the regions of the camera sensor 34 in which partial images 52 are situated, a reduction of the amount of data by a factor of 5.5 can thus be achieved. The data rate would then be less than 1 Gb/s.

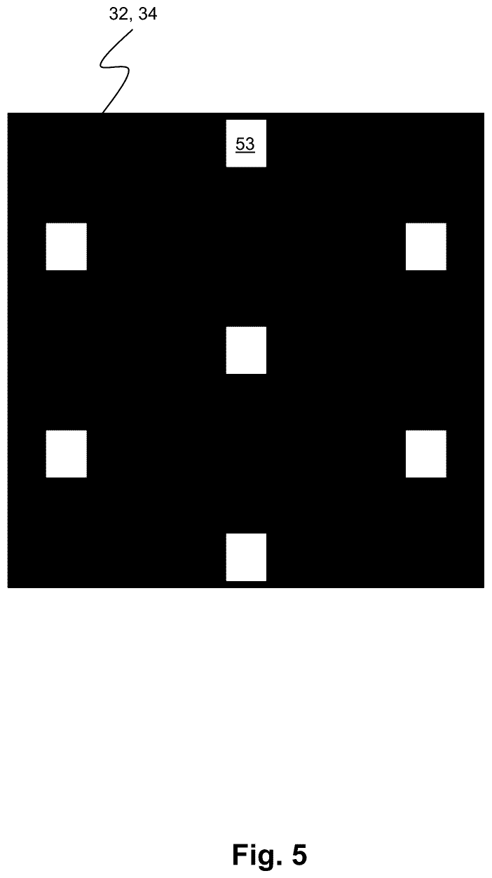

A further example, in which the image field size is unchanged in comparison with the situation in FIG. 3, but the number of partial images is reduced, is explained in association with FIG. 5.

In contrast to FIGS. 3 and 4, in FIG. 5 only the partial images of a total of 7 individual lenses of the multi-lens array 20 are read, corresponding to 5% of all the pixels of the camera sensor 34. That corresponds to a reduction of the amount of data by a factor of 19.

A reduced number of partial images with a full image field, as in FIG. 5, can be expedient in order to navigate through a sample. It is often sufficient here to transmit and display a small number of images, for example fewer than 5, in order to find relevant and interesting sample positions and to ensure the focusing. In these cases, a reconstruction of the three-dimensional sample information is not necessarily carried out, and the image data are thus not absolutely necessary for computation, with the result that the loss of information caused by dispensing with many of the partial images is acceptable for this operating mode.

FIG. 6 schematically shows one example of a multi-lens array 20 in which the lenses are not all identical. Specifically, there is firstly a central lens 23 having a comparatively large diameter and a large numerical aperture. Around the central partial lens 23, eight identical middle lenses 21 are arranged on a first ring, and their diameter is approximately equal to half that of the central lens 23. Respectively identical outer lenses 22 are then arranged on an outer ring, and their diameter is in turn approximately equal to half that of the middle lenses 21. Advantageously, all the lenses 20, 21 and 22 have the same focal length. The numerical aperture of the outer lenses 22 is less than that of the middle lenses 21. The numerical aperture of the middle lenses 21 is less than that of the central lens 23.

A larger region of the objective pupil is allotted to the central lens 23, and the central lens 23 therefore yields a better resolution. By means of the proposed method, the partial image associated with the central lens 23 can then be transmitted with full resolution, for example, while all the other partial images are transmitted optionally with lower resolution. If only an overview image is of interest, a transmission of the partial images associated with the lenses 21 and 22 can possibly be dispensed with.

### LIST OF REFERENCE SIGNS

1 Light source
2 Excitation light
3 Main beam splitter MBS
4 Back focal plane of the microscope objective 5, pupil plane
5 Microscope objective
6 Sample
7 Lens, tube lens
8 Emission light
9 Intermediate image plane, optically conjugate to the illuminated plane of the sample 6
10 Lens
11 Relay optical unit consisting of lenses 7 and 10
12 Pupil plane, optically conjugate to the back focal plane 4 of the microscope objective 5
13 Optical axis
20 Multi-lens array
21 Lens of the multi-lens array 20
22 Lens of the multi-lens array 20
23 Lens of the multi-lens array 20
30 Camera
32 Plane in which the camera sensor 34 is arranged, optically conjugate to the illuminated plane of the sample 6
34 Camera sensor
36 Camera controller, in particular microcontroller or FPGA
40 Control unit
42 Camera driver
44 Frame grabber
46 Central computing unit
50 Image data set
51 Partial image
52 Partial image
53 Partial image
100 Device according to the invention, light field arrangement, light field microscope
n_{R} Number of the pixels of the camera sensor(s) 34 which are read
n_{E} Number of the pixels of the camera sensor(s) 34 whose measurement data are processed further

What is claimed is:

1. Method for microscopy, wherein the following method steps are carried out:
by a light field arrangement comprising a multi-lens array and a camera having at least one camera sensor, image data sets which each contain at least one partial image of a sample are successively recorded, measurement data from pixels of the at least one camera sensor in each case being read out,
wherein in order to increase a number of the image data sets which are recordable per unit time, at least one of the following method steps is carried out:
a) measurement data only from a first number of pixels of the at least one camera sensor are read out, the first number being less than a total number of the pixels;
b) measurement data only from a second number of pixels of the at least one camera sensor are processed further, the second number being less than the total number of the pixels or the first number of the pixels read; and
c) for some or all of the total number of the pixels or the first number of pixels read, measurement data are processed further with a bit depth which is reduced in comparison with a maximum possible bit depth.

2. Method according to claim 1,
wherein three-dimensional sample information is reconstructed at least from a selection of image data of the partial images.

3. Method according to claim 1,
wherein the number of the image data sets of the camera sensor which are recorded per unit time is increased by reducing a number of the pixels to be read.

4. Method according to claim 1,
wherein pixels in one region or in a plurality or all of the regions of the camera sensor which satisfy one or more of the following conditions are not read or the measurement data thereof are not, or not completely, evaluated:
the measurement data of the pixels in the region or the regions contain no image information;
the measurement data of the pixels in the region or the regions cannot contain image information;
sample information can be extracted only with difficulty from the measurement data of the pixels in the region or the regions; and
the measurement data of the pixels in the region or the regions are not required for the reconstruction of three-dimensional sample information.

5. Method according to claim 1,
wherein at least one of the method steps of:
selecting pixels of the camera sensor that are to be read;
selecting pixels of the camera sensor that are to be evaluated; and
processing measurement data from pixels of the camera sensor that are to be evaluated;
is carried out partly or completely in one or more of the following components:
camera controller, in particular microcontroller or FPGA;
camera driver of the control unit; and
frame grabber of the control unit.

6. Method according to claim 1,
wherein a number of partial images of an image data set that are to be evaluated is reduced in order to increase a number of the image data sets which are recordable per unit time.

7. Method according to claim 1,
wherein a size of the image field during the recording of one image data set or a series of image data sets in the case of one partial image or a plurality or all of the partial images is reduced in comparison with a maximum possible size of the image field.

8. Method according to claim 1,
wherein the size of an image field of at least one partial image or the size of an image field of a plurality or all of the partial images in the case of a sequence of recordings of image data sets is altered from one recording to the following recording.

9. Method according to claim 1,
wherein the measurement data from one partial image or from a plurality or all of the partial images of an image data set are evaluated differently.

10. Method according to claim 1,
wherein at least one of the parameters:
size of the image field,
resolution, and
bit depth,
is defined individually in each case for one partial image or a plurality or all of the partial images, depending on the properties of that lens of the multi-lens array which has generated the relevant partial image on the camera sensor.

11. Method according to claim 1,
wherein a region illuminated on and/or in the sample is varied temporally and/or spatially.

12. Method according to claim 1,
wherein the sample is illuminated with a light sheet.

13. Method according to claim 12,
wherein the light sheet is scanned through the sample, different regions on or in the sample being illuminated depending on the scanning position of the light sheet.

14. Method according to claim 1,
wherein the partial images of an image data set in each case show an only partly illuminated sample.

15. Method according to claim 1,
wherein a region of pixels of the camera sensor that are to be read and/or evaluated is coordinated with a region illuminated on or in the sample in such a way that only measurement data from pixels in regions of the camera sensor which correspond to illuminated regions of the sample are read out and/or evaluated.

16. Method according to claim 1,
wherein in the case of a selection of image data of an image data set or in the case of all image data of an image data set, a dynamic range is reduced in comparison with a dynamic range with which the image data were originally recorded.

17. Method according to claim 1,
wherein the image data are compressed in order to reduce the dynamic range.

18. Method according to claim 1,
wherein the resolution of the camera is reduced in comparison with a maximum possible resolution.

19. Device for microscopy comprising:
a light source for emitting excitation light,
an illumination beam path for guiding the excitation light onto or into a sample,
a detection beam path at least comprising a microscope objective and a multi-lens array for guiding emission light to a camera, said emission light being emitted by the sample as a consequence of being impinged on by the excitation light,
the camera for sequentially recording image data sets which each contain at least one partial image of the sample, the camera having at least one camera sensor and a camera controller, and
a control unit for interacting at least with the camera controller and for evaluating image data supplied by the camera,
wherein in order to increase a number of image data sets which are recordable per unit time, at least one of the following features is realized:
A) the camera controller is configured to read out measurement data only from a first number of pixels of the at least one camera sensor, the first number being less than a total number of the pixels;
B) the control unit and/or the camera controller are/is configured to process further measurement data only from a second number of pixels of the at least one camera sensor, the second number being less than the total number of the pixels or the first number of the pixels read; and
C) the control unit and/or the camera controller are/is configured to process further measurement data from some or all of the pixels read with a bit depth which is reduced in comparison with a maximum possible bit depth.

20. Device according to claim 19,
wherein the multi-lens array is arranged in a plane optically conjugate to the back focal plane of the microscope objective, or in the vicinity of such a plane, or
wherein the multi-lens array is arranged in an intermediate image plane or in the vicinity of an intermediate image plane.

21. Device according to claim 19,
wherein the camera controller contains a microcontroller or an FPGA or is realized by a microcontroller or an FPGA.

22. Device according to claim 19,
wherein the control unit is configured for reconstructing three-dimensional sample information at least from a selection of the image data supplied by the camera.

23. Device according to claim 19,
wherein the partial images of an image data set are rectangular, and
wherein the camera sensor is oriented relative to the partial images such that pixel lines and pixel columns of the camera sensor are aligned parallel to the edges of the partial images.

24. Device according to claim 19,
wherein the control unit has one or more of the following component parts:
camera driver; and
frame grabber.

25. Device according to claim 19,
wherein the multi-lens array has different lenses.

26. Device according to claim 19,
wherein the illumination beam path comprises a scanner for the purpose of spatially and temporally manipulating a region illuminated on and/or in the sample.

27. Device according to claim 19,
wherein the control unit is configured to control one or both of the following components:
scanner; and
field stop.

28. Device according to claim 19,
wherein the control unit is configured to coordinate a region of pixels of the camera sensor that are to be evaluated with a region illuminated on or in the sample in such a way that only measurement data from pixels in regions of the camera sensor which correspond to illuminated regions of the sample are evaluated.

29. Device according to claim 19,
wherein the illumination beam path comprises a microscope objective and a stop for setting a numerical aperture of the microscope objective.

30. Device according to claim 19,
wherein the illumination beam path is configured for illuminating the sample with a light sheet oriented obliquely with respect to the optical axis.

31. Device according to claim 19,
wherein a field stop is present for the purpose of setting a size of the image field in the detection beam path and/or in the illumination beam path.
